(19) United States
(12) Patent Application Publication
(10) Pub. No.: US 2020/0189428 A1
(43) Pub. Date: Jun. 18, 2020

(54) SHEET-TYPE HEATING ELEMENT AND ARMREST OF VEHICLE DOOR INCLUDING THE SAME

(71) Applicants: Hyundai Motor Company, Seoul (KR); Kia Motors Corporation, Seoul (KR); SEOYON E-HWA CO., LTD., Seoul (KR)

(72) Inventors: Dong Han Kim, Yongin-si (KR); Eui Bae Kim, Anyang-si (KR)

(21) Appl. No.: 16/572,147

(22) Filed: Sep. 16, 2019

(30) Foreign Application Priority Data
Dec. 12, 2018 (KR) 10-2018-0160359

(51) Int. Cl. B60N 2/56; B60N 2/75

(52) U.S. Cl. CPC B60N 2/5685; B60N 2/75

(57) ABSTRACT

A sheet-type heating element includes: an insulation layer for insulation; a first electrode disposed on the insulation layer and including a plurality of first branches; a second electrode disposed on the insulation layer and including a plurality of second branches; and a plurality of heating conductors arranged in parallel and electrically connected with the plurality of first branches and the plurality of second branches, each of the plurality of heating conductors having a higher resistance value than the first electrode and the second electrode to generate heat.

### CROSS-REFERENCE TO RELATED APPLICATION

This application is claims the benefit of priority to Korean Patent Application No. 10-2018-0160359, filed in the Korean Intellectual Property Office on Dec. 12, 2018, the entire contents of which are incorporated herein by reference.

### TECHNICAL FIELD

The present disclosure relates to a sheet-type heating element and an armrest of a vehicle door including the same.

### BACKGROUND

Recently, an auxiliary heating device using a heating wire has been widely used in a vehicle, in addition to a main heating device such as a heater core due to a relatively long period of time required for the heater to heat the entire inner space of the vehicle while the heating wire can reach a target temperature in a shorter period of time by Joule heating.

Accordingly, an auxiliary heating means such as a heating wire installed in seats or armrests of a vehicle can efficiently provide pleasant and comfortable environment to passengers.

However, when an armrest includes a wire-type heating element therein according to related art has several problems, for example, as the wire-type heating element according to related art uses a heating wire, workability and a feeling of cushion of the armrest are deteriorated due to the thickness of a heating-wire pad.

### SUMMARY

The present disclosure has been made to solve the above-mentioned problems occurring in the prior art while advantages achieved by the prior art are maintained intact.

An aspect of the present disclosure provides a sheet-type heating element for solving the above-mentioned drawbacks of the wire-type heating element using the heating wire, and an armrest of a vehicle door that includes the sheet-type heating element.

Another aspect of the present disclosure provides a sheet-type heating element for solving the problem in which a heating function itself is disabled when a portion of the wire-type heating element in the related art has a short circuit, and an armrest of a vehicle door that includes the sheet-type heating element.

Another aspect of the present disclosure provides a sheet-type heating element for rapidly reaching a predetermined target temperature, and an armrest of a vehicle door that includes the sheet-type heating element.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a sheet-type heating element includes: an insulation layer; a first electrode disposed on the insulation layer and including a plurality of first branches; a second electrode disposed on the insulation layer and including a plurality of second branches; and a plurality of heating conductors arranged in parallel and electrically connected with the plurality of first branches and the plurality of second branches, each of the plurality of heating conductors having a higher resistance value than the first electrode and the second electrode to generate heat.

According to another aspect of the present disclosure, a sheet-type heating element includes: a conductor plate transmitting electricity; an insulating material dividing the conductor plate into two electrically-disconnected areas; and a plurality of heating conductors electrically connecting the two electrically-disconnected areas of the conductor plate, and including a material having a higher resistance value than a material of the conductor plate.

According to still another aspect of the present disclosure, an armrest of a vehicle door includes: a frame covering the armrest to configure an appearance of the armrest; a first polymer layer disposed on the frame; a sheet-type heating element disposed on the first polymer layer and receiving electric power from outside to generate heat; a second polymer layer disposed on the sheet-type heating element; and a cover layer disposed on the second polymer layer and exposed to the outside.

The sheet-type heating element includes an insulation layer provided for insulation, a first electrode formed on the insulation layer and including a plurality of first branches, a second electrode formed on the insulation layer and including a plurality of second branches, and a plurality of heating conductors that electrically connect the plurality of first branches and the plurality of second branches in parallel.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a sheet-type heating element according to an embodiment of the present disclosure;

FIG. 2 is a sectional view taken along line A-A′ of FIG. 1;

FIG. 3 is a view illustrating an armrest of a vehicle door and the sheet-type heating element installed on the armrest;

FIG. 4 is a schematic view illustrating a cross-section of the armrest of FIG. 3;

FIG. 5 is a view illustrating an embodiment in which a plurality of sheet-type heating elements are installed on an armrest of a vehicle door; and

FIGS. 6A-6H are views illustrating a process of manufacturing a sheet-type heating element according to an embodiment of the present disclosure.

### DETAILED DESCRIPTION

Hereinafter, exemplary embodiments of the present disclosure will be described in detail with reference to the accompanying drawings. It should be understood that even if shown in different drawings, identical elements are provided with identical reference numerals in the drawings. Furthermore, in describing the embodiments of the present disclosure, detailed descriptions related to well-known functions or configurations will be omitted when they may make subject matters of the present disclosure unnecessarily obscure.

Terms, such as “first”, “second”, “A”, “B”, “(a)”, “(b)”, and the like, may be used herein to describe elements of the present disclosure. Such terms are only used to distinguish one element from another element, and the substance, sequence, order, or number of these elements is not limited by these terms. If a component were described as “connected”, “coupled”, or “linked” to another component, they may mean the components are not only directly “connected”, “coupled”, or “linked” but also are indirectly “connected”, “coupled”, or “linked” via a third component.

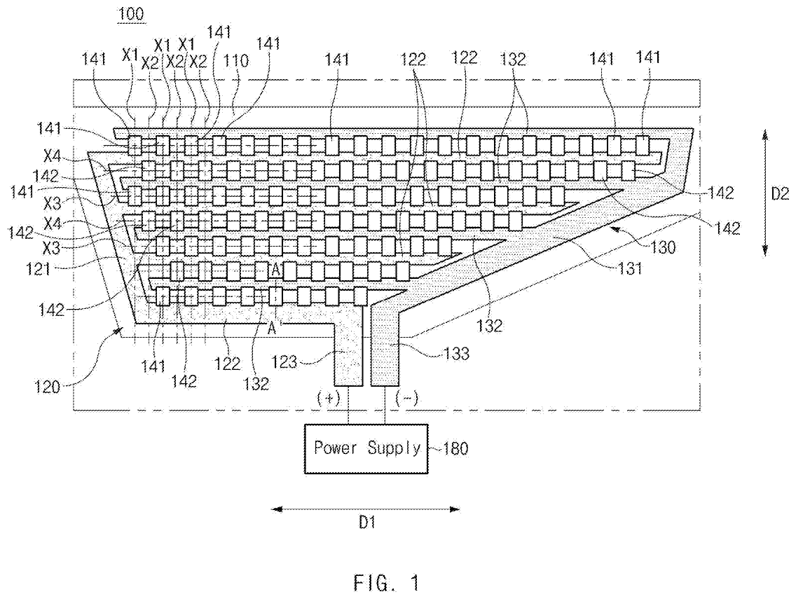

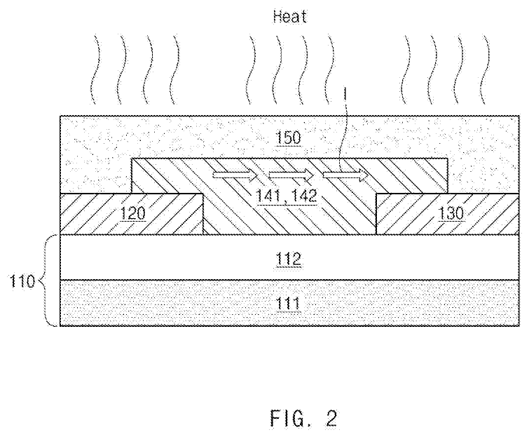

FIG. 1 is a view illustrating a sheet-type heating element according to an embodiment of the present disclosure, and FIG. 2 is a sectional view taken along line A-A′ of FIG. 1.

A sheet-type heating element 100 according to an embodiment includes an insulation layer 110, a first electrode 120, a second electrode 130, and a plurality of first and second heating conductors 141, 142.

The insulation layer 110 is provided for insulation of the sheet-type heating element 100. The insulation layer 110 may be configure to define contour of the sheet-type heating element 100.

The first electrode 120 is disposed on the insulation layer 110 and includes a plurality of first branches 122.

The second electrode 130 is disposed on the insulation layer 110 and includes a plurality of second branches 132.

The plurality of heating conductors 141, 142 are electrically connected in parallel by the plurality of first branches 122 and the plurality of second branches 132. Each heating conductor 141, 142 may include a material having higher resistance per unit area than the first electrode 120 and the second electrode 130 and may generate heat by Joule heating when electric current flows through the each heating conductor 141, 142. That is, the plurality of heating conductors 141, 142 may more effectively generate heat by Joule heating than the first electrode 120 and the second electrode 130.

The sheet-type heating element 100 is configured such that the plurality of heating conductors 141, 142 generate heat when the first electrode 120 and the second electrode 130 are connected to a power supply 180.

In related art, a heating wire is used to provide a heating element on an armrest of a vehicle door. In the case of the wire-type heating element, a long heating wire in an electrically serially connected shape can be installed on the armrest of the vehicle door by bending the long heating wire several times to increase heating performance.

However, the wire-type heating element applied to the armrest of the vehicle door according to related art has the following problems: i) the wire-type heating element fails to reach a target temperature or it takes a relatively long period of time to reach the target temperature; ii) power consumption is excessive; and iii) workability and a feeling of padding (or a feeling of cushion) of the armrest are deteriorated due to the thickness of a heating-wire pad.

The sheet-type heating element 100 according to an embodiment of the present disclosure and an armrest 10 of a vehicle door 1 that includes the same have been made to solve the above-mentioned problems of the wire-type heating element for an armrest of a vehicle door in the related art. More specifically, the sheet-type heating element 100 according to an embodiment has a basic feature wherein the sheet-type heating element 100 includes the plurality of heating conductors 141, 142 that electrically connect the plurality of first branches 122 and the plurality of second branches 132 in parallel. The plurality of heating conductors 141, 142 include a material having higher resistance per unit area than the first electrode 120 and the second electrode 130, thereby rapidly reaching a target temperature, reducing power consumption, and improving a feeling of cushion of the armrest 10 while increasing workability in manufacturing the armrest 10 having a heating function.

That is, the sheet-type heating element 100 according to the present disclosure includes the plurality of heating conductors 141, 142 for generating heat and the first electrode 120 and the second electrode 130 for supplying electric power to the heating conductors 141, 142, and the plurality of heating conductors 141, 142 are electrically connected in parallel. Accordingly, the sheet-type heating element 100 may have a small thickness relative to the wire-type heating element in related art. In addition, because the heating conductors 141, 142 are electrically connected in parallel rather than in series, electric current may be evenly and rapidly supplied to all of the heating conductors 141, 142 to generate heat.

Therefore, the sheet-type heating element 100 according to the present disclosure has effects of i) rapidly reaching a target temperature, ii) reducing power consumption, and iii) minimizing the thickness of the heating element 100 and thus increasing workability in manufacturing the armrest 10 and improving a feeling of cushion (or a feeling of padding) of the armrest 10.

Features of the sheet-type heating element 100 according to this embodiment will be described below in more detail.

Referring to FIG. 2, the insulation layer 110 may include a plurality of layers. For example, the insulation layer 110 may be formed by laminating a first insulation layer 111 and a second insulation layer 112.

The first insulation layer 111 and the second insulation layer 112 may have different thicknesses. The first insulation layer 111 and the second insulation layer 112 may have different materials. For example, the first insulation layer 111 and the second insulation layer 112 may be formed of one of polymers such as polyurethane (PU), polyethylene terephthalate (PET), and the like.

The first insulation layer 111 and the second insulation layer 112 may be formed by laminating.

The first electrode 120 and the second electrode 130 may be printed on the insulation layer 110. For example, the first electrode 120 and the second electrode 130 may be formed on the insulation layer 110 by screen printing.

The first electrode 120 and the second electrode 130 may be electrically disconnected from each other. Insulation may fill space between the first electrode 120 and the second electrode 130 to electrically disconnect the first electrode 120 and the second electrode 130. For example, a coating layer 150, which will be described below, may fill the space between the first electrode 120 and the second electrode 130 to electrically disconnect the first electrode 120 and the second electrode 130.

The first electrode 120 and the second electrode 130 may be formed by dividing a conductor plate into two electrically/physically separated areas by an insulating material. The first electrode 120 and the second electrode 130, which are the two electrically/physically separated areas of the conductor plate, may be electrically connected together by the plurality of heating conductors 141, 142. At this time, the plurality of heating conductors 141, 142 may be electrically connected in parallel by the first electrode 120 and the second electrode 130.

Referring to FIG. 1, the first electrode 120 may include at least one first trunk 121, and the plurality of first branches 122 may branch from the first trunk 121.

The first trunk 121 may have a larger cross-sectional area than the first branches 122.

The first trunk 121 may extend along a periphery of a predetermined heating area.

In an embodiment, when the heating area is divided by a virtual center line that extends along a second direction D2, the first trunk 121 may be provided at an edge of a partial area on one side of the heating area (e.g., a left-side area of the heating area in FIG. 1). Referring to FIG. 1, for example, the first trunk 121 may extend along a left-side edge of the heating area.

The plurality of first branches 122 may branch from the first trunk 121 and may extend across the heating area. Referring to FIG. 1, for example, each first branch 122 may extend from the first trunk 121 along a first direction D1. The first direction D1 may be a longitudinal direction of the sheet-type heating element 100 (or the insulation layer 110), the second direction D2 may be a transverse direction of the sheet-type heating element 100 (or the insulation layer 110), the second direction D2 may be perpendicular to the first direction D1.

In one embodiment, an axis of each first branch 122 intersects an axis of the first trunk 121 at a predetermined angle. In other embodiment, the axis of each first branch 122 is perpendicular to the axis of the first trunk 121.

The second electrode 130 may include at least one second trunk 131, and the plurality of second branches 132 may branch from the second trunk 131.

The second trunk 131 may have a larger cross-sectional area than the second branches 132.

The second trunk 131 may be formed along a periphery of the predetermined heating area.

In an embodiment, when the heating area is divided by the virtual center line that extends along the second direction D2, the second trunk 131 may be provided at an edge of a partial area on the other side of the heating area (e.g., a right-side area of the heating area in FIG. 1). Referring to FIG. 1, for example, the second trunk 131 may extend along a right-side edge of the heating area.

The plurality of second branches 132 may branch from the second trunk 131 and may extend across the heating area. Referring to FIG. 1, for example, each second branch 132 may extend from the second trunk 131 along the first direction D1.

In one embodiment, an axis of each second branch 132 intersects an axis of the second trunk 131 at a predetermined angle. In other embodiment, the axis of each second branch 132 is perpendicular to the axis of the second trunk 131.

Referring to FIG. 1, the plurality of first branches 122 and the plurality of second branches 132 may be alternately arranged and equidistantly spaced along the second direction D2 to cross-finger pattern.

The plurality of heating conductors 141, 142 may be disposed between first branch 122 and second branch 132 that are adjacent along the second direction D2. The plurality of heating conductors 141, 142 may include a plurality of heating conductors 141 and a plurality of second heating conductors 142. The plurality of first heating conductors 141 are equidistantly spaced from each other along the first direction D1, the plurality of first heating conductors 141 are equidistantly spaced from each other along the second direction D2. Each first heating conductor 141 may have an upper end directly attached to the second branch 132 and a lower end directly attached to the first branch 122. The plurality of second heating conductors 142 are equidistantly spaced from each other along the first direction D1, the plurality of second heating conductors 142 are equidistantly spaced from each other along the second direction D2. Each second heating conductor 142 may have an upper end directly attached to the first branch 122 and a lower end directly attached to the second branch 132. Therefore, the plurality of heating conductors 141, 142 may be electrically and/or physically connected in parallel by the first electrode 120 and the second electrode 130. That is, an electric current may flow in parallel from the first electrode 120 to the second electrode 130 through the plurality of heating conductors 141, 142.

In an embodiment, at least one first branch 122 among the plurality of first branches 122, may be positioned between two second branches 132 adjacent along the second direction D2. The at least one first branch 122 may be electrically connected to two second branches 132 adjacent along the second direction D2 by the plurality of first and second heating conductors 141, 142.

For example, referring to FIG. 1, among the plurality of first branches 122, the first branch 122 between two second branches 132 that are adjacent along the second direction D2 may be electrically connected with the two adjacent second branches 132 by the plurality of heating conductors 141, 142.

In an embodiment, a plurality of heating conductors connecting a 1-1 branch and a 2-1 branch and a plurality of heating conductors connecting the 1-1 branch and a 2-1 branch may be asymmetrical ith respect to the second direction D2. For example, referring to FIG. 1, the plurality of heating conductors 141, 142 that electrically connect the first branch 122 between the second branches 132 with respect to the second direction D2, among the plurality of first branches 122, and the second branch 132 located on one side of the first branch 122 and adjacent thereto and the plurality of heating conductors 141, 142 that electrically connect the first branch 122 and the second branch 132 located on the other side of the first branch 122 and adjacent thereto may be asymmetrical with respect to the second direction D2.

Referring to FIG. 1, the plurality of first heating conductors 141 may be aligned along an first imaginary axis X1 parallel to the second direction D2, the plurality of second heating conductors 142 may be aligned along an second imaginary axis X2 parallel to the second direction D2, the first imaginary axis X1 may be parallel to the second imaginary axis X2. In particular, the first imaginary axis X1 and the second imaginary axis X2 may be alternately arranged and equidistantly spaced from each other along the first direction D1. Therefore, the plurality of first heating conductors 141 and the plurality of second heating conductors 142 may be alternately arranged and equidistantly spaced from each other along the first direction D1.

Referring to FIG. 1, the plurality of first heating conductors 141 may be aligned along an third imaginary axis X3 parallel to the first direction D1, the plurality of second heating conductors 142 may be aligned along an fourth imaginary axis X4 parallel to the first direction D1, the third imaginary axis X3 may be parallel to the fourth imaginary axis X4, the third imaginary axis X3 and the fourth imaginary axis X4 may be perpendicular to the first imaginary axis X1 and the second imaginary axis X2. In particular, the third imaginary axis X3 and the fourth imaginary axis X4 may be alternately arranged and equidistantly spaced from each other along the second direction D2. Therefore, the plurality of first heating conductors 141 and the plurality of second heating conductors 142 may be alternately arranged and equidistantly spaced from each other along the second direction D2.

Above mentioned, the plurality of first heating conductors 141 and the plurality of second heating conductors 142 may be alternately arranged and equidistantly spaced from each other along the first direction D1 and the second direction D2.

The first electrode 120 may include a first electrode terminal 123 connected to an external power supply 180), and the second electrode 130 may include a second electrode terminal 133 connected to the external power supply 180. The first electrode terminal 123 and the second electrode terminal 133 may extend together from one side of the sheet-type heating element 100, but may be spaced apart from each other by a predetermined distance so as not to be electrically connected together.

The sheet-type heating element 100 may further include a connector terminal for protecting the first electrode terminal 123 and the second electrode terminal 133. The first electrode terminal 123 and the second electrode terminal 133 may be connected to a positive (+) electrode and a negative (−) electrode of the external power supply 180, respectively. In contrast, the first electrode terminal 123 may be connected to the negative (−) electrode of the external power supply 180, and the second electrode terminal 133 may be connected to the positive (+) electrode of the external power supply 180.

The sheet-type heating element 100 may receive electric power from a power supply device of the vehicle. For example, the sheet-type heating element 100 may generate heat using electric power received from an energy storage device such as a battery of the vehicle.

Referring to FIG. 2, when the direction in which the insulation layer 110, the first and second electrodes 120 and 130, and the coating layer 150 are laminated is referred to as a lamination direction, the first electrode 120 and the second electrode 130 may have a shape in which a width in a perpendicular direction to the lamination direction is greater than a thickness in the lamination direction. Furthermore, a portion of each heating conductor 141, 142 located between the first electrode 120 and the second electrode 130 may have a shape in which a width in the perpendicular direction to the lamination direction is greater than a thickness in the lamination direction.

In an embodiment, the first electrode 120 and the second electrode 130 may have a shape in which the width in the perpendicular direction to the lamination direction is twice of or more times greater than the thickness in the lamination direction.

In an embodiment, the portion of each heating conductor 141, 142 located between the first electrode 120 and the second electrode 130 may have a shape in which the width in the perpendicular direction to the lamination direction is twice of or more times greater than the thickness in the lamination direction.

Accordingly, heat generated by the sheet-type heating element 100 may be effectively released to the outside through the coating layer 150, and the thickness of the sheet-type heating element 100 in the lamination direction may be minimized.

Referring to FIG. 2, the heating conductors 141, 142 may be formed to overlap the first electrode 120 and the second electrode 130 with respect to the lamination direction. That is, referring to FIG. 2, each of the heating conductors 141, 142 may include a portion inserted between the first electrode 120 and the second electrode 130, a portion laminated on the first electrode 120, and a portion laminated on the second electrode 130.

In this case, the plurality of heating conductors 141, 142 include portions that overlap the first electrode 120 and the second electrode 130, but are not directly electrically connected together. Accordingly, the plurality of heating conductors 141, 142 are electrically connected in parallel by the first electrode 120 and the second electrode 130.

In a case where the first electrode 120 is connected to the positive (+) electrode of the external power supply 180 and the second electrode 130 is connected to the negative (−) electrode of the external power supply 180, the heating conductors 141, 142 may generate heat by Joule heating when electric current I flows from the first electrode 120 to the second electrode 130 through the heating conductors 141, 142.

The plurality of heating conductors 141, 142 may be formed of at least one of carbon black, positive temperature coefficient (PTC), or carbon nanotube. Accordingly, the heating conductors 141, 142 may effectively generate heat when electric current flows through the heating conductors 141, 142.

The plurality of heating conductors 141, 142 may be printed on the insulation layer 110. For example, the plurality of heating conductors 141, 142 may be printed on the insulation layer 110 by screen printing.

According to the sheet-type heating element 100 of the present disclosure, the heating conductors 141, 142 mainly generate heat. However, it should be understood that the first electrode 120 and the second electrode 130 can also generate heat by Joule heating when electric current flows through the first electrode 120 and the second electrode 130.

Referring to FIG. 2, the sheet-type heating element 100 may further include the coating layer 150 with which the first electrode 120, the second electrode 130, and the plurality of heating conductors 141, 142 are coated for insulation.

When the heating conductors 141, 142 overlap with the first electrode 120 and the second electrode 130, the coating layer 150 may have filling portions in which the heating conductors 141, 142 do not overlap the first and second electrodes 120 and 130. That is, the coating layer 150 may include a sheet-shaped portion having a predetermined thickness and a portion protruding from the sheet-shaped portion toward the first electrode 120 or the second electrode 130.

Because heat generated by the plurality of heating conductors 141, 142 is released to the outside through the coating layer 150, the coating layer 150 may be formed of a material that has an insulation characteristic, but has excellent thermal conductivity.

In an embodiment, the insulation layer 110, the first electrode 120, the second electrode 130, the heating conductors 141, 142, and the coating layer 150 may have a thickness of 0.1 mm to 1 mm in the lamination direction of the insulation layer 110, the first electrode 120, the second electrode 130, the heating conductors 141, 142, and the coating layer 150 to make the sheet-type heating element 100 flexible.

For example, the first insulation layer 111 of the insulation layer 110 may be formed of polyurethane and have a thickness of about 0.2 mm, and the second insulation layer 112 may be formed of polyethylene terephthalatte and have a thickness of about 0.025 mm. The coating layer 150 may be formed of polyurethane and have a thickness of about 0.2 mm. The first electrode 120, the second electrode 130, and the heating conductors 141, 142 may be formed such that the sheet-type heating element 100 has a total thickness of about 0.65 mm.

According to the above-configured sheet-type heating element 100, the heating conductors 141, 142 are evenly distributed over the entire heating area so that heat may be uniformly generated from the entire heating area and electric current may be efficiently supplied to the heating conductors 141, 142 by the first electrode 120 and the second electrode 130 to generate heat.

In particular, because the plurality of heating conductors 141, 142 are asymmetrical, electrical interference in the sheet-type heating element 100 may be reduced when the sheet-type heating element 100 operates, and therefore the heating conductors 141, 142 may effectively generate heat.

Furthermore, even though any one of the heating conductors 141, 142 is abnormal, the remaining heating conductors 141, 142 may generate heat because the plurality of heating conductors 141, 142 are electrically connected in parallel. In addition, even though any one of the plurality of first branches 122 or the plurality of second branches 132 has a short circuit, the electrical connection may be maintained by the remaining branches and therefore the heating function of the sheet-type heating element 100 may be maintained.

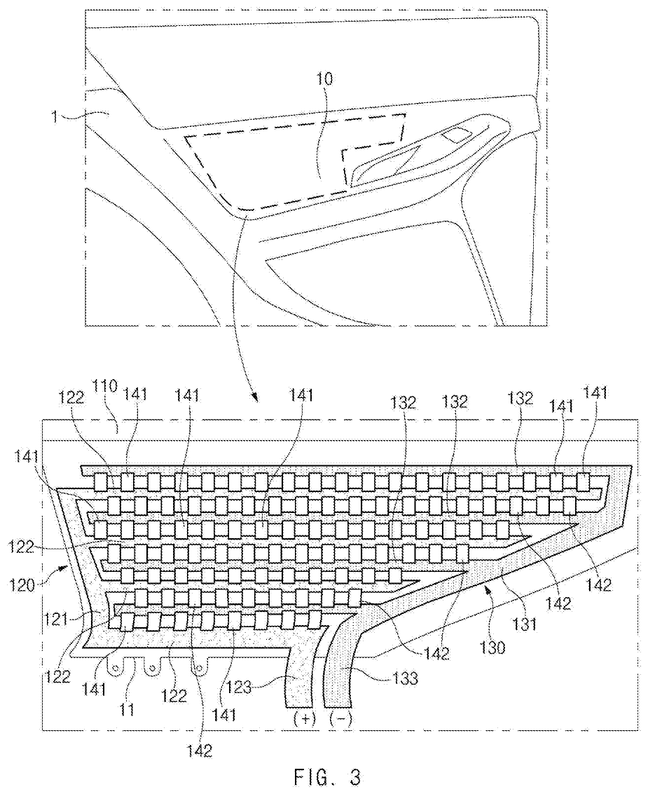

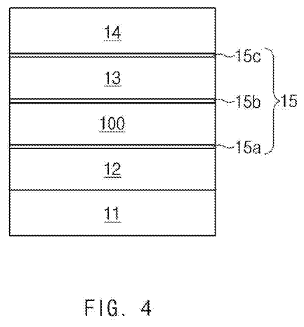

FIG. 3 is a view illustrating the armrest of the vehicle door and the sheet-type heating element installed on the armrest, and FIG. 4 is a schematic view illustrating a cross-section of the armrest of FIG. 3.

Referring to FIG. 3, the armrest 10 of the vehicle door 1 may be a component that includes a trim of the vehicle door 1 and a flat portion for supporting an arm. The armrest 10 may have a shape in which a portion between the trim of the vehicle door 1 and the flat portion for supporting an arm is smoothly curved.

The sheet-type heating element 100 according to this embodiment may be installed on a predetermined area of the armrest 10 including the smoothly curved shape, which is illustrated in FIG. 3.

The sheet-type heating element 100 according to this embodiment may be flexible and may be curved to match the curved shape of the armrest 10. The armrest 10 may be covered with leather, with the sheet-type heating element 100 curved and attached to the armrest 10.

Referring to FIG. 4, the armrest 10 may include a frame 11, a first polymer layer 12, the sheet-type heating element 100, a second polymer layer 13, and a cover layer 14.

The frame 11 may form the appearance of the armrest 10.

The first polymer layer 12 may be disposed on the frame 11 to bond the sheet-type heating element 100 to the frame 11. The first polymer layer 12 may include at least one of polymers such as polyurethane, polyethylene terephthalate, and the like. For example, the first polymer layer 12 may be implemented with a polyurethane foam pad.

The sheet-type heating element 100 may be disposed on the first polymer layer 12 and may receive electric power from the outside to generate heat.

The second polymer layer 13 may be disposed on the sheet-type heating element 100 and may bond the sheet-type heating element 100 and the cover layer 14. The second polymer layer 13 may include at least one of polymers such as polyurethane, polyethylene terephthalate, and the like. For example, the second polymer layer 13 may be implemented with polyurethane SLAB foam.

The cover layer 14 may be disposed on the second polymer layer 13 and may be exposed to the outside. The cover layer 14 may be formed of a material that is normally used as an interior material of a vehicle. For example, the cover layer 14 may be formed of leather or leatherette.

Adhesive layers 15 may be provided to bond the components of the armrest 10 together. For example, the adhesive layers 15 may include a first adhesive layer 15a for bonding the first polymer layer 12 and the sheet-type heating element 100, a second adhesive layer 15b for bonding the sheet-type heating element 100 and the second polymer layer 13, and a third adhesive layer 15c for bonding the second polymer layer 13 and the cover layer 14.

FIG. 5 is a view illustrating an embodiment in which a plurality of sheet-type heating elements are installed on an armrest of a vehicle door.

Referring to FIG. 5, a plurality of sheet-type heating elements according to the present disclosure may be installed on a plurality of areas of the armrest of the vehicle door, respectively.

For example, the sheet-type heating elements 100 may be installed on a trim area A1 of the vehicle door and a support area A2 of the armrest.

In general, the sheet-type heating element 100 installed on the wide support area A2 that is more likely to be brought into contact with a user's arm may generate heat in a relatively wide area, and the sheet-type heating element 100 installed on the narrow trim area A1 that is less likely to be brought into contact with the user's arm may generate heat in a relatively narrow area.

Furthermore, the sheet-type heating element 100 installed on the trim area A1 and the sheet-type heating element 100 installed on the support area A2 may be on/off controlled. Accordingly, the user may adjust the sheet-type heating elements 100 according to necessity.

In addition, the sheet-type heating element 100 installed on the trim area A1 and the sheet-type heating element 100 installed on the support area A2 may have different specifications. For example, the sheet-type heating element 100 installed on the trim area A1 may have more excellent performance in heating temperature or time taken to generate heat than the sheet-type heating element 100 installed on the support area A2, thereby efficiently providing heat to the user.

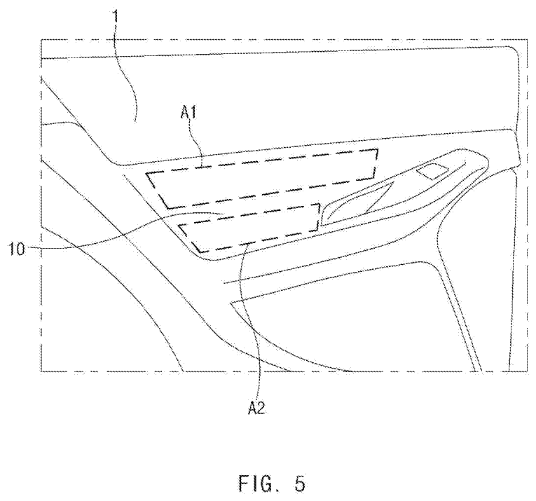

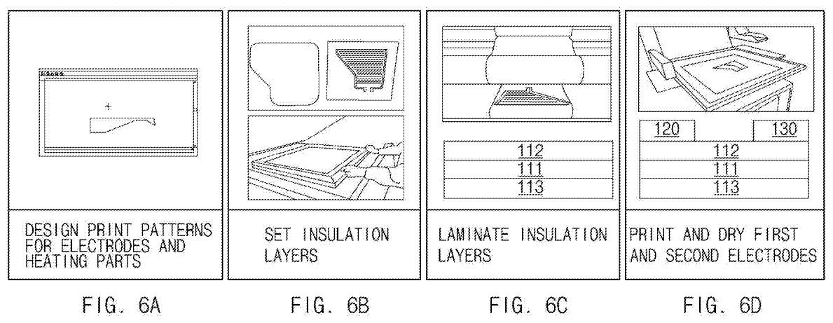

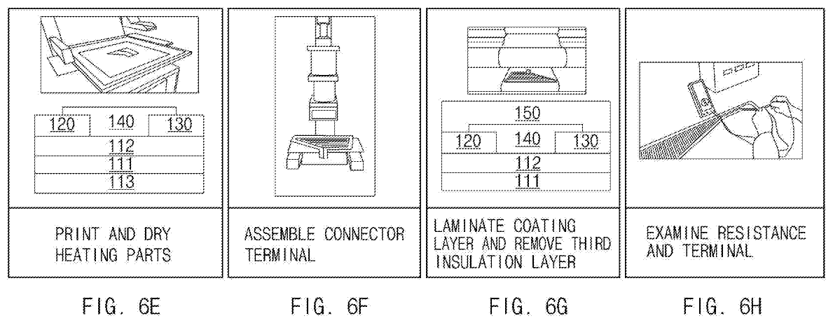

FIGS. 6A-6H are views illustrating a process of manufacturing a sheet-type heating element according to an embodiment of the disclosure.

Print patterns for first and second electrodes 120 and 130 and heating conductors 141, 142 of a sheet-type heating element are prepared as shown in FIG. 6A. This step may include a step of designing the print patterns for the first and second electrodes 120 and 130 and the heating conductors 141, 142 of the sheet-type heating element or preparing the designed print patterns.

Insulation layers are set as shown in FIG. 6B. The insulation layers are set in an apparatus for printing the first and second electrodes 120 and 130 and the heating conductors 141, 142.

The insulation layers are laminated using the apparatus shown in FIG. 6C. The insulation layers include a first insulation layer 111, a second insulation layer 112, and a third insulation layer 113. The first insulation layer 111 may be formed of a polyurethane film and may have a thickness of about 0.2 mm. The second insulation layer 112 may be formed of a polyethylene terephthalate film and may have a thickness of about 0.025 mm. The third insulation layer 113 may be formed of a polyethylene terephthalate film and may have a thickness of about 0.15 mm.

Referring to FIG. 6D, the first electrode 120 and the second electrode 130 are printed on the second insulation layer 112 and then dried. The first electrode 120 and the second electrode 130 are printed on the second insulation layer 112 according to the prepared print pattern and then dried.

As shown in FIG. 6E, the heating conductors 141, 142 are printed on the second insulation layer 112 and then dried. The heating conductors 141, 142 are printed on the second insulation layer 112 according to the prepared print pattern and then dried. At this time, the heating conductors 141, 142 may be formed to overlap the first electrode 120 and the second electrode 130. That is, the heating conductors 141, 142 may be formed to have a T-shaped cross-section.

A connector terminal is assembled as shown in FIG. 6F. The connector terminal may protect an electrode terminal of the first electrode 120 and an electrode terminal of the second electrode 130 and may electrically connect an external power supply 180 and the electrode terminals of the first and second electrodes 120 and 130.

Referring to FIG. 6G, a coating layer 150 is laminated, and the third insulation layer 113 is removed.

Then, referring to FIG. 6H, resistance and the terminals are examined to identify whether electrical connection is formed normally.

As described above, the sheet-type heating element according to the present disclosure may be manufactured through a simpler process than a wire-type heating element in the related art.

A process of installing the sheet-type heating element on an armrest of a vehicle door will be described below.

First, a cover layer (reference numeral 14 of FIG. 4) and a first intermediate product in which a frame (reference numeral 11 of FIG. 4), a first polymer layer (reference numeral 12 of FIG. 4), and the sheet-type heating element (reference numeral 100 of FIG. 4) are bonded together are prepared. At this time, a second polymer layer (reference numeral 13 of FIG. 4) may be provided on the first intermediate product or the cover layer.

Next, the cover layer is bonded to the first intermediate product to cover the first intermediate product. At this time, an adhesive material may be applied between the first intermediate product and the cover layer.

An armrest may be manufactured in a different way from that described above.

For example, a frame (reference numeral 11 of FIG. 4), a first polymer layer (reference numeral 12 of FIG. 4), the sheet-type heating element (reference numeral 100 of FIG. 4), and a second polymer layer (reference numeral 13 of FIG. 4) are bonded together, and a portion of a cover layer (reference numeral 14 of FIG. 4) is bonded to the second polymer layer.

An unbonded portion of the cover layer is bonded to cover the frame (reference numeral 11 of FIG. 4), the first polymer layer (reference numeral 12 of FIG. 4), the sheet-type heating element (reference numeral 100 of FIG. 4), and the second polymer layer (reference numeral 13 of FIG. 4).

The sheet-type heating element may have a small thickness relative to a wire-type heating element in the related art. Therefore, the sheet-type heating element may solve the problem in which a cover layer is partially lifted or is not bonded well in a finishing process of covering an armrest with the cover layer, such as leather, when manufacturing the armrest. In addition, the sheet-type heating element may improve a feeling of padding (or a feeling of cushion) of the armrest.

According to the embodiments of the present disclosure, at least the following effects can be achieved.

The sheet-type heating element includes the plurality of heating conductors that electrically connect the plurality of first branches and the plurality of second branches in parallel and that are formed of a material having higher resistance per unit area than the first electrode and the second electrode, and the plurality of heating conductors generate heat when the first electrode and the second electrode are connected to a power supply, whereby the sheet-type heating element may achieve a small thickness relative to a wire-type heating element using a heating wire in the related art. As a result, workability and a feeling of cushion of the armrest can be improved.

Furthermore, even though some of the heating conductors have a short circuit, the electrical connection of the sheet-type heating element may be maintained, and thus the heating function may be maintained.

In addition, the plurality of heating conductors are electrically connected in parallel, whereby the sheet-type heating element may rapidly reach a predetermined target temperature and may reduce power consumption, compared with a wire-type heating element in the related art.

Effects of the present disclosure are not limited to the aforementioned effects, and any other effects not mentioned herein will be clearly understood from the accompanying claims by those skilled in the art to which the present disclosure pertains.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A sheet-type heating element comprising:
an insulation layer;
a first electrode disposed on the insulation layer and including a plurality of first branches;
a second electrode disposed on the insulation layer and including a plurality of second branches; and
a plurality of heating conductors arranged in parallel and electrically connected with the plurality of first branches and the plurality of second branches, each of the plurality of heating conductors having a higher resistance value than the first electrode and the second electrode to generate heat.

2. The sheet-type heating element of claim 1, wherein the first electrode includes at least one first trunk from which the plurality of first branches branch, and
wherein the second electrode includes at least one second trunk from which the plurality of second branches branch.

3. The sheet-type heating element of claim 2, wherein the at least one first trunk has a cross-sectional area larger than that of each of the plurality of first branches, and
wherein the at least one second trunk has a cross-sectional area larger than that of each of the plurality of second branches.

4. The sheet-type heating element of claim 2, wherein the plurality of first branches and the plurality of second branches extend in a first direction,
wherein the plurality of first branches and the plurality of second branches are alternately arranged with respect to a second direction that is perpendicular to the first direction, and
wherein the plurality of heating conductors are alternately arranged between the plurality of first branches and the plurality of second branches.

5. The sheet-type heating element of claim 4, wherein at least one first branch among the plurality of first branches is electrically connected to two second branches adjacent along the second direction by the plurality of heating conductors.
wherein each of the two second branches is adjacent the one first branch at opposite sides of the one first branch.

6. The sheet-type heating element of claim 5, wherein the plurality of heating conductors includes the plurality of first heating conductors and the plurality of second conductor,
each of the plurality of first heating conductors has a upper end directly attached to the second branch and a lower end directly attached to the first branch,
each of the plurality of second heating conductors has a upper end directly attached to the first branch and a lower end directly attached to the second branch,
the plurality of first heating conductors and the plurality of second heating conductors are alternately arranged and equidistantly spaced from each other along the second direction.

7. The sheet-type heating element of claim 2, wherein the first trunk and the second trunk are disposed along a periphery of a predetermined heating area,
wherein the plurality of first branches branch from the first trunk and extend across the heating area, and
wherein the plurality of second branches branch from the second trunk and extend across the heating area.

8. The sheet-type heating element of claim 1, wherein the insulation layer includes a polymer.

9. The sheet-type heating element of claim 1, wherein the first electrode and the second electrode include a metallic material.

10. The sheet-type heating element of claim 1, wherein the plurality of heating conductors include at least one of carbon black, positive temperature coefficient (PTC), or carbon nanotube.

11. The sheet-type heating element of claim 1, further comprising:
a coating layer coated on the first electrode, the second electrode, and the plurality of heating conductors for insulation,
wherein the insulation layer, the first electrode, the second electrode, the plurality of heating conductors, and the coating layer in combination have a thickness of 0.1 mm to 1 mm in a stacking direction of the insulation layer, the first electrode, the second electrode, the plurality of heating conductors, and the coating layer to allow the sheet-type heating element flexible.

12. A sheet-type heating element comprising:
a conductor plate transmitting electricity;
an insulating material dividing the conductor plate into two electrically-disconnected areas; and
a plurality of heating conductors electrically connecting the two electrically-disconnected areas of the conductor plate, each of the plurality of heating conductors including a material having a higher resistance value than a material of the conductor plate.

13. An armrest of a vehicle door, the armrest comprising:
a frame covering the armrest to configure an appearance of the armrest;
a first polymer layer disposed on the frame;
a sheet-type heating element disposed on the first polymer layer and receiving electric power from outside to generate heat;
a second polymer layer disposed on the sheet-type heating element; and
a cover layer disposed on the second polymer layer and exposed to the outside,
wherein the sheet-type heating element includes:
an insulation layer for insulation;
a first electrode disposed on the insulation layer and including a plurality of first branches;
a second electrode disposed on the insulation layer and including a plurality of second branches; and
a plurality of heating conductors disposed in parallel and configured to electrically connect the plurality of first branches and the plurality of second branches.
